(19) United States
(12) Patent Application Publication
(10) Pub. No.: US 2006/0164831 A1
(43) Pub. Date: Jul. 27, 2006

(54) Pigtail light string

(76) Inventor: Win-Ching Lai, Lujhu Township (TW)

Correspondence Address: LIN & ASSOCIATES INTELLECTUAL PROPERTY, P.O. BOX 2339, SARATOGA, CA, 95070-0339, US

(21) Appl. No.: 11/044,385

(22) Filed: Jan. 27, 2005

(51) Int. Cl. F21V 9/00

(52) U.S. Cl. 362/231

(57) ABSTRACT

A pigtail light string is provided for using in a conventional light string. The pigtail light string includes a conductive line connecting at least two or more light modules in parallel. The light modules includes LEDs of at least two colors and a control circuit board for generating different lighting patterns, such as colors, brightness, duration, and so on. Each light module is enclosed in a translucent decorative shell. One end of the conductive line is attached to a power plug for plugging into a socket of a light bulb on a conventional light string. The shape of the power plug is that of the base of a bulb used in a conventional light string so that the pigtail light string can be plugged into a socket for receiving a bulb on a conventional light string. When used in combination with conventional light strings, the pigtail light string provides a wider range of light change patterns as well as various decorative styles.

### FIELD OF THE INVENTION

The present invention generally relates to a light string, and more specifically to a pigtail light string having more change patterns and drawing power from a light bulb socket of a conventional light string.

### BACKGROUND OF THE INVENTION

The conventional light strings are mostly made of tungsten and stringed in a serial manner. After a long period of use, the temperature of the light bulbs will arise. When one of the light bulbs burned out, the entire light string will cease to function. In addition, most conventional light strings have a limited range of light change patterns, such as blinking, round-robin style of light color change, and so on. With the advance of lighting technologies in the last decade, the conventional light strings are losing their attraction. A newer, more attractive and versatile light string is in demand.

A new product can gain more market acceptance if the new product is compatible with the older competitive products, and provide improved functionality that the older product could not deliver. This is important as the older product may have a steady market hold and may still be functional. For most users, the attraction of a newer product is less than the economic consideration unless the new product provides some imperative functions that are vital to the user. Therefore, it is important for the new versatile light string to work with conventional light string, and provide additional functions to compliment the lack of versatility in the conventional light strings. The pigtail light string is proposed based on the aforementioned compatibility philosophy.

### SUMMARY OF THE INVENTION

The present invention has been made to overcome the above-mentioned drawback of conventional light strings. The primary object of the present invention is to provide a pigtail light string compatible with conventional light string to provide a wider range of light change patterns so that the conventional light strings can extends their lifespan. The structure of the present invention includes a plurality of light modules, and each module includes LEDs of two colors. Because each module can display the all-same, all-different, or sequential color change, so that the overall string will display a great variety of color change patterns.

Another object of the present invention is to provide a pigtail tree-top light by using a single or a plurality of light modules, combined with the decorative shells, such as a star of the top of a Christmas tree. This can be used to replace the conventional tree-top light. So, instead of plugging in the electricity plug directly, the present invention is more convenient by plugging in the socket of a conventional light string.

Yet another object of the present invention is to provide a light string with more styles. By putting different styles of decorative shells to enclose the light modules, such as ice cone, or sphere, the light modules of the present invention can have same or different style of decorative shells. By changing the color of the enclosed light module, the various decorative shells of the pigtail light string can display a wide range of visual effects.

To achieve the aforementioned objects, the pigtail light string of the present invention includes a conductive line connecting at least two or more light modules in parallel. The light modules includes LEDs of at least two colors and a control circuit board for generating different lighting patterns, such as colors, brightness, duration, and so on. Each light module is enclosed in a translucent decorative shell. One end of the conductive line is attached to a power plug for plugging into a socket of a light bulb on a conventional light string.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a three-dimensional view of a first embodiment according to the invention;

FIG. 2 shows a explosive view of the light module and the decorative shell of the present invention;

FIG. 3 shows a schematic view of the present invention assembled with a conventional light string;

FIG. 4 shows a second embodiment of the present invention; and

FIG. 5 shows a third embodiment of the present invention.

### DETAILED DESCRIPTION OF THE PREFERRED EMBODIMENTS

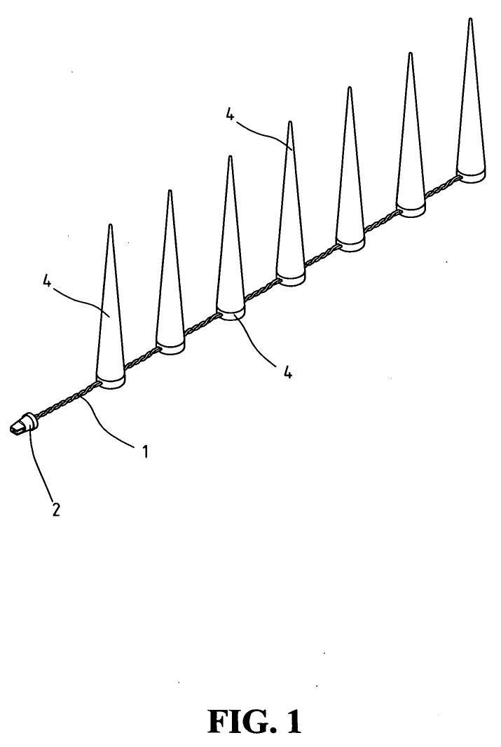

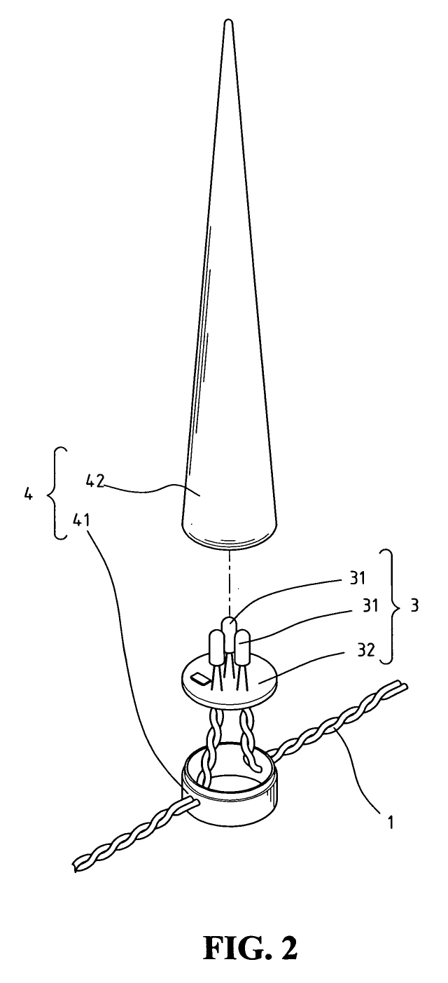

As shown in FIG. 1 and FIG. 2, the pigtail light string of the present invention includes a power conductive line 1, power connector 2, a plurality of light modules 3, and a plurality of decorative shells 4. Power connector 2 is attached to one end of power conductive line I for electrical connection. Light modules 3, each enclosed in a decorative shell, are installed on power conductive line in parallel.

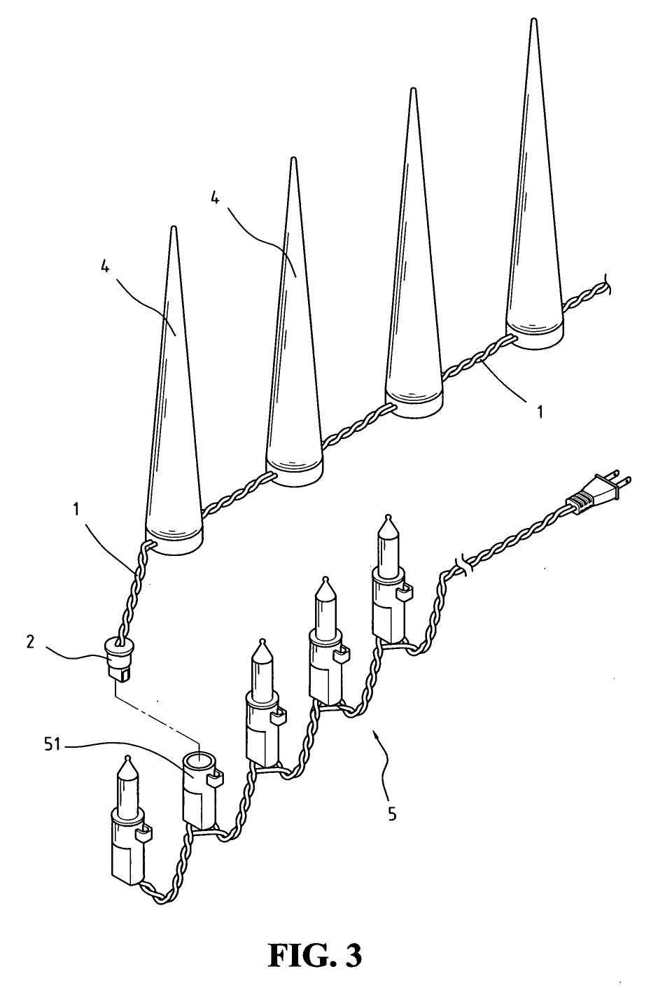

Power conductive line I are installed with two or more light modules 3 in parallel. Power connector 2 has the shape of the base of a conventional light bulb used in a conventional light string 5, so that it can be plugged into a socket 51 for receiving a conventional light bulb on conventional light string 5, as shown in FIG. 3. The shape of power connector 2 is not limited to the embodiment shown in FIG. 3. The base of any light bulb in a conventional light string can be used as the shape for power connector 2. Therefore, power connector 2 can be made in any shape to be used with different conventional light strings.

Light module 3 includes LEDs 31 of two or more colors and a control circuit board 32. The output color of the light module is the result of uniform blending of the colors of all the LEDs within the module. This embodiment uses a red LED, a blue LED and a green LED; however, other embodiments may use a plurality of LEDs capable of generating multiple colors, or even LED array. Control circuit board 32 is for controlling and driving LEDs 31. Control circuit board 32 includes related circuit and chips (not shown), and provides three basic functions:
(1) outputting a stable direct current (DC) by transforming a alternative current (AC) drawn from socket 51;
(2) driving LEDs 31 of various color and control the brightness at appropriate time to provide a light of the intended color to the external view; and
(3) controlling the time, spacing and sequence of each light module 3 by using second-shifting so that the entire light string can display light of various color in sequence or by using synchronization for blinking or interleaved blinking effects.

Decorative shell 4 is for enclosing light module 3 and provides water-proof protection so that the entire light string is safe for outdoor use. Decorative shell 4 allows the light of different colors emitted by light module 3 to blend well inside, so that the external view of decorative shell 4 is a light of a single color. Therefore, the internal surface of decorative shell 4 can be processed with a matte or a layer of material to diffuse the light. In this embodiment, decorative shell 4 includes a base 41 and a shell 42. Base 41 is for holding light module 3 in place, and shell 4 can be made of a variety of shapes or styles in accordance with the design, for example, the present embodiment uses a conic icicle. A sealing glue can be applied after the assembly.

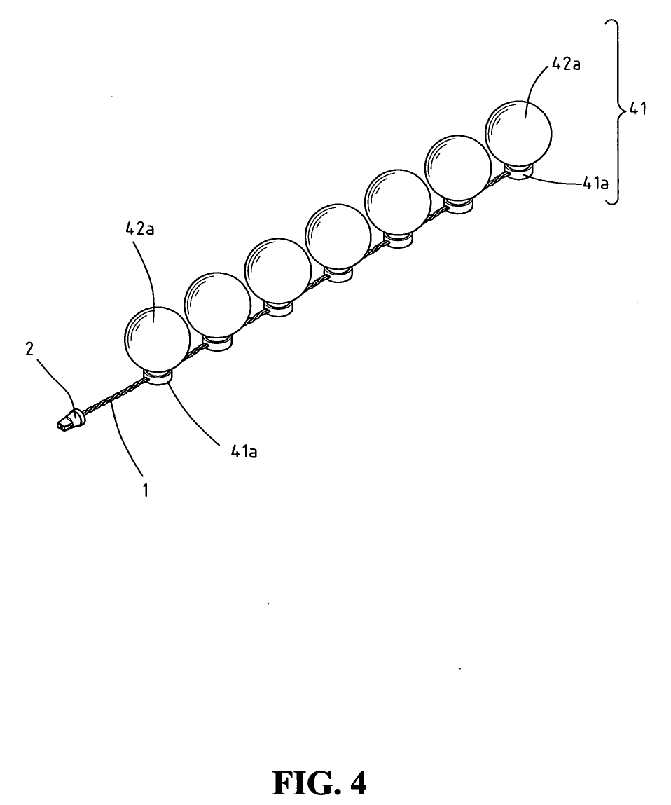

FIG. 4 shows a second embodiment of the present invention. The main structure of the present invention is similar to that of the first embodiment, except that decorative shell 4a has a different style. In this embodiment, shell 42a of decorative shell 4a is a translucent hollow sphere, and light module 3 is also fixed at base 41a. As shown in these embodiments, the shape and the styles of decorative shells 4 of the present invention can be varied according to the design purpose. It can be either figurine, start, or any other shape. In addition, not all the decorative shells of a light string must be identical. A light string of the present invention may include different decorative shells for different light modules.

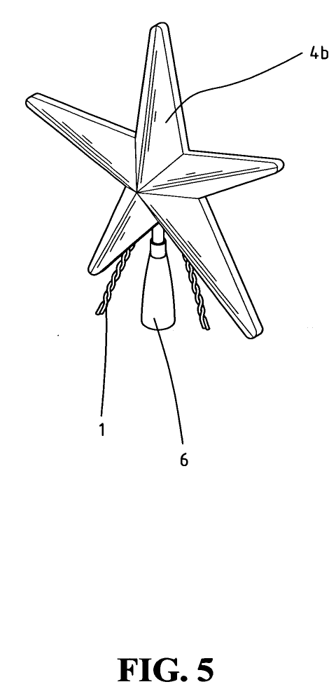

FIG. 5 shows a third embodiment of the present invention. The main structure of the present invention is similar to that of the first embodiment, but it is used on a different occasion, namely, a tree-top light. The shape of decorative shell 4b of this embodiment is a three-dimensional star, translucent on both sides. Light module 3 is installed at the center of the shell. The present embodiment uses five LEDs, with each capable of emitting red, blue and green light to project on each of the spikes of the star. With this design, the present embodiment can display a star having different light color or various patterns on each of the spikes. When used with a connecting stand 6, decorative shell 4b can be placed on the top of a Christmas tree and used as a pigtail tree-top light. Compared to the conventional tree-top light using the electrical plug on the wall to draw power, the present invention is more convenient and safer.

In summary, the present invention provides a pigtail light string, which can be used in combination with conventional light strings to provide a wider range of light change patterns as well as various decorative styles. In addition to being used as a light string, the present invention can also be used as s tree-top light in a safer and more convenient way.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pigtail light string, comprising:
a power conductive line, having one end connected to a power connector, said power connector shaped to match a socket for receiving a bulb on a conventional light string;
a plurality of light modules, installed in parallel on said power conductive line, said light module further comprising a control circuit board and LEDs of at least two different colors, said control circuit board transforming an AC from said socket into a stable DC to drive said LEDs for controlling the color of the output light; and
a plurality of decorative shells, with each enclosing a said light module.

2. The light string as claimed in claim 1, wherein the internal surface of said decorative shell is matte.

3. The light string as claimed in claim 1, wherein the internal surface of said decorative shell is covered with a layer of glass sand.

4. The light string as claimed in claim 1, wherein said decorative shell further comprises
a translucent shell having the shape of a hollow sphere and a base, said light module is installed on said base.

5. The light string as claimed in claim 1, wherein said decorative shell further comprises
a shell having the shape of a conic icicle and a base, said light module is installed on said base

6. The light string as claimed in claim 1, wherein said decorative shell further comprises
a shell having the shape of a three-dimensional hollow star and a base, said light module is installed on said base and said plurality of LEDs of said light module emits light onto the spikes of said star-shaped shell.

7. The light string as claimed in claim 1, wherein said light module comprises a plurality of LEDs, with each capable of emitting lights of a single color.

8. The light string as claimed in claim 1, wherein said light module comprises a single LED capable of emitting lights of at least two colors.

9. The light string as claimed in claim 1, wherein said light module comprises a plurality of LEDs, with each capable of emitting lights of at least two colors.
